(19) United States
(12) Patent Application Publication
(10) Pub. No.: US 2010/0180770 A1
(43) Pub. Date: Jul. 22, 2010

(54) Maritime Vessel Black and Gray water tank vent gas adsorption filter

(76) Inventors: Louis John Pagano, West Milford, NJ (US); Anthony James Prisco, JR., Cinnaminson, NJ (US); Mark Steven Russo, Northvale, NJ (US)

Correspondence Address: Louis Pagano, 6 Jacobs Road, West Milford, NJ, 07480, US

(21) Appl. No.: 12/355,979

(22) Filed: Jan. 19, 2009

(51) Int. Cl. B01D 53/14

(52) U.S. Cl. 96/108

(57) ABSTRACT

The objective of the unit 10 is mainly to adsorb Hydrogen Sulfide gas (also known as H2S) and other gases including but not limited to Carbon Dioxide 26 from maritime vessel wastewater management system vents 21 thereby removing the odor and or greenhouse gasses associated with the air stream/gas 26. The disc containment system 14 eliminates the need for a Media bag or cartridge reducing maintenance costs.

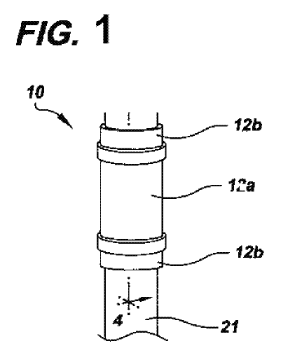

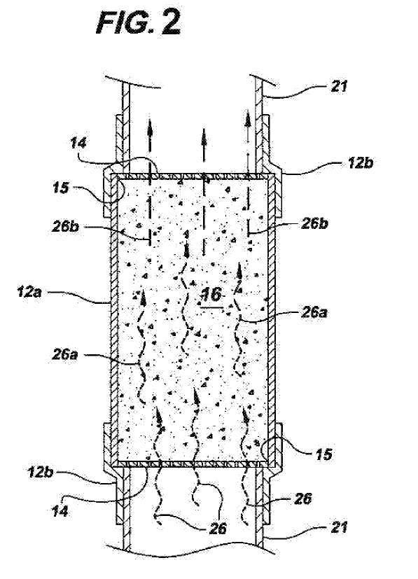

An air adsorber or filter also called an air scrubber that mounts inline of the existing blackwater, grey water or waste water vents in a Marine Vessel and is designed to adsorb escaping gasses thereby removing any odors and greenhouse gases that are emitted. Those gasses include but not limited to Hydrogen Sulfide, Carbon Dioxide, and Methane. For the purpose of promoting and understanding of the invention numbered references will be made to the invention illustrated in the drawings. Item 10 in the drawings is the overall invention.

Housing—12A Serves as the main body of the unit 10. The preferred material for construction of the inventions housing 10 is schedule 40 PVC (Poly Vinyl Chloride). However, any other form of Plastic, Plastic composite, Resin, Resin composite metal or metal alloy may be utilized in any combination to create the housing 10. Containing the filter media 16.

Perforated Discs 14—Are preferably made of ⅛ inch thick gray PVC sheet stock with 3/32 inch holes spaced every 5/32 of an inch. However the discs 14 may be manufactured from any form of plastic, plastic composite, Resin, Resin composite metal, metal alloy or any combination thereof and the spacing and size of the perforated holes may vary to accommodate various forms of media 16 and airflow. Each disc 14 is cut to a round shape of varied size to accommodate the opening of the different sized filter housings 12a, however the shape of the disc can vary to accommodate any shape needed to fit the filter housing openings 12a. These discs are ultra sonic welded, thermal welded, chemically boded, press fit or can be molded as a single unit with the main filter housing 12a as needed into each opening of the housing 12a 2 each are used in the cylindrical, inline design 12a. The perforated discs 14 may also be an integral part of the housing 12a mold eliminating the need to cut and install the discs 14. The discs 14 help contain the filter media 16 within the housing 12a and the perforations allow the vent gasses 26 to pass through the housing 12a (top to bottom), over the contained media bed 16.

Media Bed 16 Can be a variety of adsorptive materials but is mainly an activated carbon specifically developed to adsorb odorous gasses 26. For removing greenhouse gasses, the activated carbon will typically be blended with an additional media 16. The adsorptive media 16 can be a variety of materials but is mainly a granular combination of magnesium oxide, Titanium (IV) Dioxide, and Zinc Oxide. The Activated Carbon or other media 16 can also be impregnated with a variety of chemicals to perform both functions of removing odorous gasses and greenhouse gasses.

Gasses 26 that normally vent through the vent pipe 21 and into the atmosphere pass through the filter 12a through the perforated disc 14 on the inlet side of the adsorber (filter) unit 12a, then pass through the media bed 16 (typically activated carbon) where the odorous and greenhouse gas 26 is adsorbed 26b thus removing any odors and or Greenhouse gasses.

The unit 10 can (and should) be structured in an “in-line” 12a fashion so as to be placed “in-line” of the wastewater vent 21 system. The perforated disc 14 containment system allows greater flexibility in use for many different vent designs and applications. It can (and is) built in different sizes to accommodate the many sizes of vent pipes 21 and volumes of escaping gases 26 from vent systems. The unit 10 can be utilized for air filtration systems other than wastewater applications.

The unit 10 can be filled with many different types of activated carbon or other adsorbing media 16 that is designed to remove specific types of gases other than Hydrogen Sulfide and greenhouse gasses.

What is claimed is:

1. While the present invention has been described in terms of specific embodiments, it is to be understood that the invention is not limited to these disclosed embodiments. This invention may be embodied in many different forms and should not be construed as limited to the embodiments set forth herein; rather, these embodiments are provided by way of illustration only and so that this disclosure will be thorough, complete and will fully convey the full scope of the invention to those skilled in the art. Indeed, many modifications and other embodiments of the invention will come to mind of those skilled in the art to which this invention pertains, and which are intended to be and are covered by both this disclosure, the drawings and the claims.”
The unit 10 achieves its objective by utilizing a linear design with the inlet at the bottom of the vertical portion of the unit 10. The filtration Media_16 is contained in the portion of the filter housing 12a that is between the perforated discs 14 containment system. As the gasses pass through the filter housing 12a through the media 16 the odors associated with wastewater and the greenhouse gasses are removed. The gasses 26a exiting the filter 12a are filtered with odors and greenhouse gasses removed.
